(19) United States
(12) Patent Application Publication
(10) Pub. No.: US 2026/0323171 A1
(43) Pub. Date: Oct. 15, 2026

(54) IMAGING DEVICE

(71) Applicant: Japan Display Inc., Tokyo (JP)

(72) Inventor: Tomoyuki ISHIHARA, Tokyo (JP)

(21) Appl. No.: 19/644,272

(22) Filed: Apr. 10, 2026

(30) Foreign Application Priority Data
Apr. 14, 2025 (JP) 2025-066208

(51) Int. Cl. H04N 23/95; G06T 5/20; G06T 5/50

(52) U.S. Cl. CPC H04N 23/95; G06T 5/20; G06T 5/50; G06T 2207/20056; G06T 2207/20216; G06T 2207/30204

(57) ABSTRACT

According to an aspect, an imaging device includes: a planar optical sensor; a code mask; a subject housing; a storage circuit configured to store first PSF data and a first image, the first PSF data indicating a light/dark distribution of light from a point light source captured by the optical sensor through a code pattern of the code mask, and the first image being an image of a subject captured by the optical sensor through the code pattern of the code mask; and a processing circuit configured to perform image processing to generate a second image by performing a deconvolution process based on the first PSF data and the first image, adjust the first PSF data to generate second PSF data, and generate a resultant image by performing the deconvolution process based on the second PSF data and the first image.

### CROSS-REFERENCE TO RELATED APPLICATION

This application claims the benefit of priority from Japanese Patent Application No. 2025-066208 filed on Apr. 14, 2025, the entire contents of which are incorporated herein by reference.

### BACKGROUND

### 1. Technical Field

What is disclosed herein relates to an imaging device.

### 2. Description of the Related Art

Japanese Patent No. 5839428 (JP-5839428) discloses a pinhole camera. The pinhole camera includes a mask sheet provided with a pinhole and an optical sensor (light-receiving element). Light from a subject enters the optical sensor through the pinhole of the mask sheet.

In the pinhole camera according to JP-5839428, the amount of light passing through the pinhole is limited, which may make it difficult to capture clear images.

For the foregoing reasons, there is a need for an imaging device capable of capturing clearer images with reduced blur.

### SUMMARY

According to an aspect, an imaging device includes: a planar optical sensor comprising a plurality of photodiodes; a code mask that is disposed on one side in a first direction of the optical sensor so as to overlap the optical sensor and on which a code pattern is configured to be displayed; a subject housing that is disposed on the one side in the first direction of the code mask so as to overlap the code mask and is configured to accommodate a subject; a storage circuit configured to store first point spread function (PSF) data and a first image, the first PSF data indicating a light/dark distribution of light from a point light source captured by the optical sensor through the code pattern of the code mask, and the first image being an image of the subject captured by the optical sensor through the code pattern of the code mask; and a processing circuit configured to perform image processing to generate a second image by performing a deconvolution process based on the first PSF data and the first image, adjust the first PSF data to generate second PSF data, and generate a resultant image by performing the deconvolution process based on the second PSF data and the first image.

### BRIEF DESCRIPTION OF THE DRAWINGS

FIG. 1 is a perspective view schematically illustrating an imaging device according to an embodiment of the present disclosure;

FIG. 2 is an enlarged plan view of a portion of a code mask in FIG. 1;

FIG. 3 is a schematic sectional view taken along line III-III in FIG. 2;

FIG. 4 is a block diagram illustrating a configuration example of the imaging device according to the embodiment;

FIG. 5 is a schematic diagram illustrating a procedure to acquire a second image according to the embodiment;

FIG. 6 is a schematic diagram illustrating a procedure to acquire a resultant image according to the embodiment;

FIG. 7 is a schematic diagram illustrating a procedure of an image adjustment illustrated in FIG. 6;

FIG. 8 is a flowchart illustrating a procedure to select a solution of a quadratic equation in FIG. 6; and

FIG. 9 is a schematic view illustrating a test code pattern image according to a modification of the embodiment.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In xyz coordinates, an x1 side is opposite an x2 side in an x direction. A y1 side is opposite a y2 side in a y direction. A z1 side is opposite a z2 side in a z direction. The z1 side is also referred to as the lower side, and the z2 side as the upper side. The z direction is also referred to as a first direction. The z1 side is also referred to as one side in the first direction, and the z2 side as the other side in the first direction.

### EMBODIMENT

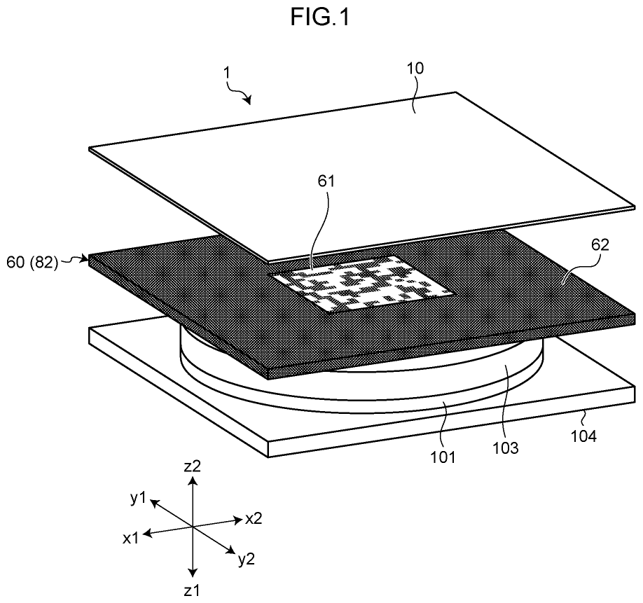

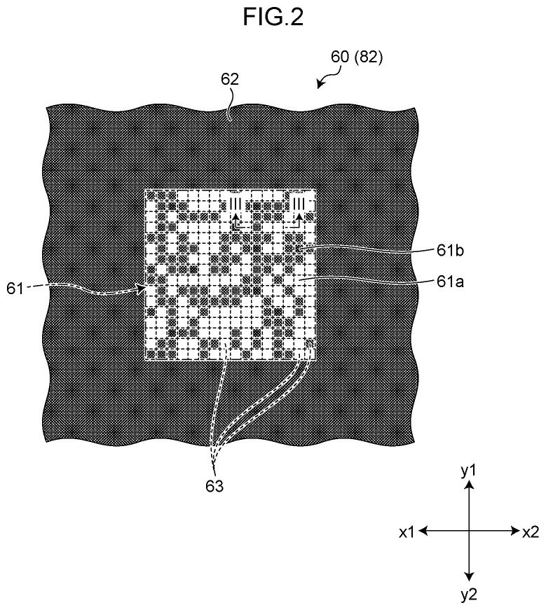

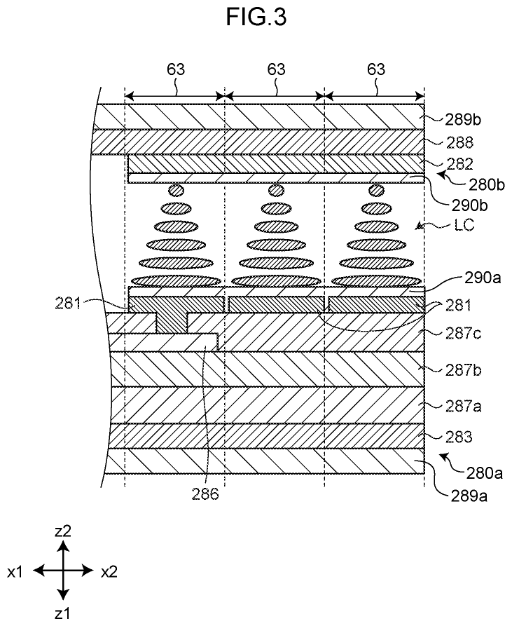

An embodiment of the present disclosure will first be described. FIG. 1 is a perspective view schematically illustrating an imaging device according to the embodiment. FIG. 2 is an enlarged plan view of a portion of a code mask in FIG. 1. FIG. 3 is a schematic sectional view taken along line III-III in FIG. 2.

As illustrated in FIG. 1, an imaging device 1 includes an optical sensor 10, a code mask 60, a subject housing 103, and a light source 104.

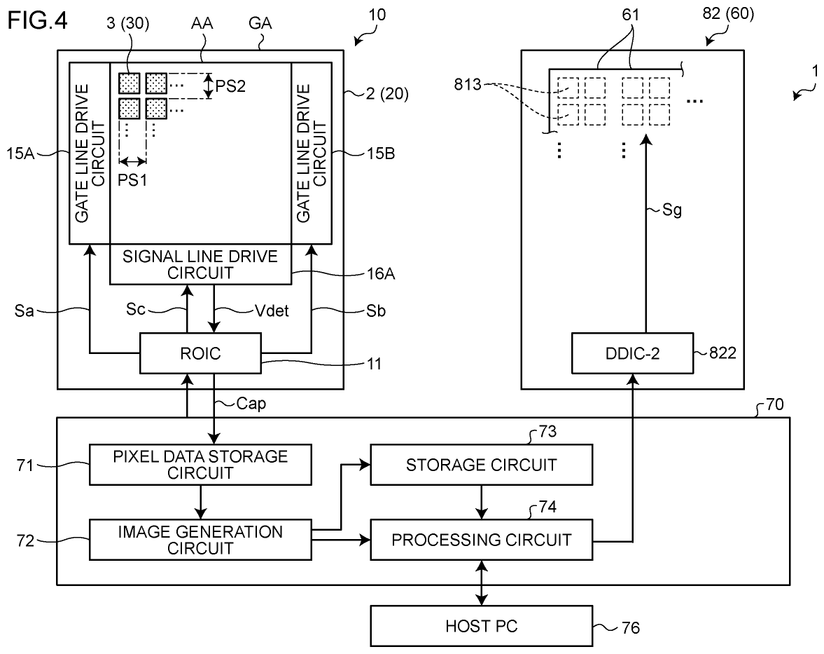

As illustrated in FIG. 1, the optical sensor 10 is a planar detection device that includes a plurality of photodiodes 30 (photodetection elements 813, refer to FIG. 4) arranged in a planar configuration. The code mask 60 is disposed on the z1 side of the optical sensor 10 so as to overlap the optical sensor 10. The code mask 60 can be made using not only a member permanently divided into a light-transmitting portion and a light-blocking portion, but also a liquid crystal shutter 82, an electrochromic shutter, and the like that can switch between the light-transmitting state and the light-blocking state in order to enable dynamic mask pattern change.

The code mask 60 is rectangular in plan view. The term “plan view” refers to a state “viewed from (along) a direction orthogonal to the optical sensor 10 or the code mask 60” or “viewed from (along) the z direction”. The code mask 60 includes a code pattern 61 and a light-blocking area 62. In the embodiment, one code mask 60 is provided with one code pattern 61, but one code mask 60 may be provided with a plurality of the code patterns 61. The code pattern 61 is positioned approximately in the center of the code mask 60. The outer shape of the code pattern 61 is rectangular, for example. The code mask 60 has the code pattern 61 and the light-blocking area 62.

As illustrated in FIG. 2, the entire surface of the liquid crystal shutter 82 as an example of the code mask 60 is divided into a plurality of square pixels 63. In detail, in the code pattern 61, each of the pixels 63 in the light-transmitting state forms a light-transmitting portion 61a, and each of the pixels 63 in the light-blocking state forms a light-blocking portion 61b. The light-blocking area 62 is formed by the pixels 63 in the light-blocking state.

As illustrated in FIG. 3, light can be transmitted or blocked by a polarizer on a light emission side of a liquid crystal layer LC by controlling the twisting state of liquid crystal molecules by turning on or off the voltage applied to electrodes for each pixel 53. That is, portions that transmit light form the light-transmitting portions 61a, and portions that block light form the light-blocking portions 61b and the light-blocking area 62.

As illustrated in FIG. 3, the pixel structure divided for each of the pixels 53 includes a first substrate 280a, a second substrate 280b, and the liquid crystal layer LC. Specifically, the second substrate 280b is spaced on the z2 side from the first substrate 280a, and the liquid crystal layer LC is provided between the second substrate 280b and the first substrate 280a.

The first substrate 280a includes a first polarizer 289a, a first transparent substrate 283, an insulating layer 287a, an insulating layer 287b, an insulating layer 287c, a first electrode 281, and a first orientation film 290a. Specifically, the first polarizer 289a, the first transparent substrate 283, the insulating layer 287a, the insulating layer 287b, the insulating layer 287c, the first electrode 281, and the first orientation film 290a are stacked in this order from the z1 side toward the z2 side.

The second substrate 280b includes a second polarizer 289b, a second transparent substrate 288, a second electrode 282, and a second orientation film 290b. Specifically, the second polarizer 289b, the second transparent substrate 288, the second electrode 282, and the second orientation film 290b are stacked in this order from the z2 side toward the z1 side.

The first polarizer 289a and the second polarizer 289b are polarizers that each transmit components of incident light that vibrate in a predetermined direction and block components of the light that vibrate in directions other than that direction.

The first transparent substrate 283 and the second transparent substrate 288 are glass substrates, for example. The first electrode 281 and the second electrode 282 are light-transmitting electrodes using indium tin oxide (ITO), for example. The first orientation film 290a and the second orientation film 290b are made of polyimide (PI), for example. The orientation films are each provided to control the orientation of the liquid crystal molecules when the liquid crystal molecules are required to be aligned in one direction over a relatively wide area. The first electrode 281 is electrically coupled to wiring 286. A switch or the like (not illustrated) causes current to flow to the first electrode 281 through the wiring 286.

With the configuration described above, the pixels 63 where current is caused to flow to the first electrode 281 become the light-transmitting portions 61a in the light-transmitting state, and the pixels 63 in the light-blocking state where current is not allowed to flow to the first electrode 281 become the light-blocking portions 61b and the light-blocking area 62. The total area of the light-transmitting portions 61a in the code pattern 61 is 40% to 60% of the total area of the code pattern 61.

As illustrated in FIG. 1, the subject housing 103 is positioned on the z1 side of the code mask 60 so as to overlap the code mask 60. The subject housing 103 accommodates therein a subject 101. The light source 104 is, for example, a backlight formed in a planar configuration. Specifically, the light source 104 has a plurality of light-emitting diodes (LEDs) or the like arranged in a planar shape to emit light evenly.

FIG. 4 is a block diagram illustrating a configuration example of the imaging device according to the embodiment. As illustrated in FIG. 4, the imaging device 1 further includes a control circuit 70 that controls the optical sensor 10. The control circuit 70 includes, for example, a microcontrol unit (MCU), a random-access memory (RAM), an electrically erasable programmable read-only memory (EEPROM), a read-only memory (ROM), and other components.

The optical sensor 10 includes an array substrate 2, a plurality of sensor pixels 3 (photodiodes 30) formed on the array substrate 2, gate line drive circuits 15A and 15B, a signal line drive circuit 16A, and an imaging circuit (ROIC) 11. The imaging circuit 11 includes a readout integrated circuit.

The array substrate 2 is formed using a substrate 20 as a base. Each of the sensor pixels 3 is configured with the photodiode 30, a plurality of transistors, and various types of wiring. The array substrate 2 with the photodiodes 30 formed thereon is a drive circuit board for driving the sensor for each predetermined detection area, and is also called a backplane or an active matrix substrate.

The substrate 20 has an active area AA and a peripheral area GA. The active area AA is an area provided with the sensor pixels 3 (photodiodes 30). The peripheral area GA is an area between the outer perimeter of the active area AA and the outer edges of the substrate 20, and is an area not provided with the sensor pixels 3. The gate line drive circuits 15A and 15B, the signal line drive circuit 16A, and the imaging circuit 11 are provided in the peripheral area GA.

Each of the sensor pixels 3 is an optical sensor that includes the photodiode 30 as a sensor element. Each of the photodiodes 30 outputs an electrical signal corresponding to light emitted thereto. More specifically, the photodiode 30 is a positive-intrinsic-negative (PIN) photodiode or an organic photodiode (OPD) using an organic semiconductor. The sensor pixels 3 (photodiodes 30) are arranged in a matrix having a row-column configuration in the active area AA. The distance between adjacent two of the sensor pixels 3 (photodiodes 30) is a distance PS1 or PS2.

The imaging circuit 11 is a circuit that supplies control signals Sa, Sb, and Sc to the gate line drive circuits 15A and 15B and the signal line drive circuit 16A, respectively, to control operations of these circuits. Specifically, the gate line drive circuits 15A and 15B output gate drive signals to gate lines based on the control signals Sa and Sb. The signal line drive circuit 16A electrically couples a signal line SLS selected based on the control signal Sc to the imaging circuit 11. The imaging circuit 11 includes a signal processing circuit that processes an imaging signal Vdet from each of the photodiodes 30.

The photodiodes 30 included in the sensor pixels 3 perform detection in response to the gate drive signals supplied from the gate line drive circuits 15A and 15B. Each of the photodiodes 30 outputs the electrical signal corresponding to the light emitted thereto as the imaging signal Vdet to the signal line drive circuit 16A. The imaging circuit 11 is electrically coupled to the photodiodes 30. The imaging circuit 11 processes the imaging signals Vdet from the photodiodes 30 and outputs pixel data Cap based on the imaging signals Vdet to the control circuit 70. The pixel data Cap is sensor values acquired from the respective sensor pixels 3.

The control circuit 70 includes a pixel data storage circuit 71, an image generation circuit 72, a storage circuit 73, and a processing circuit 74, as a control circuit for the optical sensor 10. The pixel data storage circuit 71 stores therein the pixel data Cap output from the imaging circuit 11 of the optical sensor 10. The image generation circuit 72 generates a first image IM-1, first point spread function (PSF) data 21, and other data, based on the pixel data Cap of the photodiode 30. The first image IM-1 is image data of the subject 101 captured by the optical sensor 10 through the code pattern 61 of the code mask 60. The first PSF data 21 indicates a light/dark distribution captured by the optical sensor 10 in a state where a point light source 105 faces the code mask 60.

The storage circuit 73 stores therein the first image IM-1, the first PSF data 21, and the other data.

The processing circuit 74 performs, for example, image processing to generate a second image IM-2 by performing a deconvolution process based on the first PSF data 21 and the first image IM-1, image processing to generate second PSF data 22 by adjusting the first PSF data 21, and image processing to generate a resultant image IM-4 by performing the deconvolution process based on the second PSF data 22 and the first image IM-1. This image processing operations will be described in detail later. The control circuit 70 transmits the second image IM-2 and other data to an external host personal computer (PC) 76.

The liquid crystal shutter 82 as an example of the code mask 60 includes a plurality of photodetection elements 813 (pixels 63). A control circuit (DDIC-2) 822 supplies a control signal Sg to each of the photodetection elements 813 (pixels 63) to form the light-transmitting portions 61a (refer to FIG. 2) in the light-transmitting state, and the light-blocking portions 61b and the light-blocking area 62 (refer to FIG. 2) in the light-blocking state.

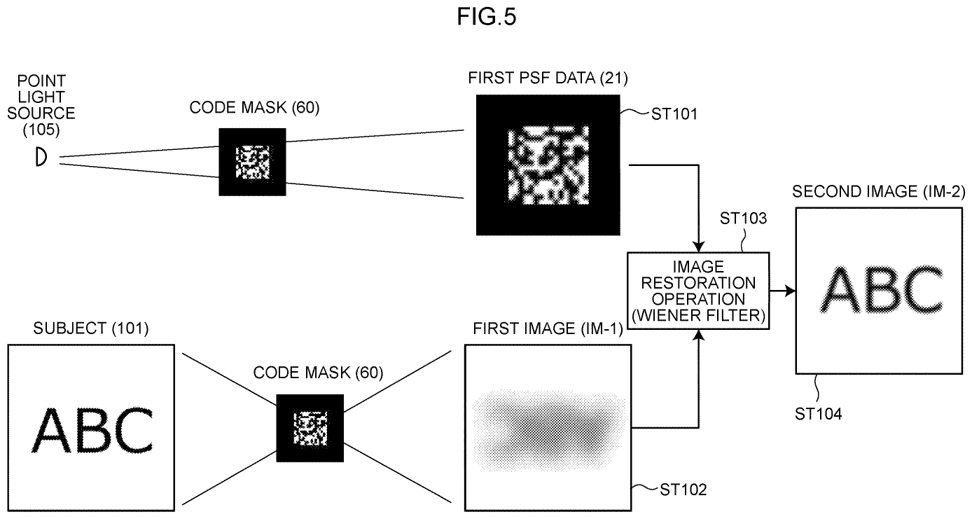

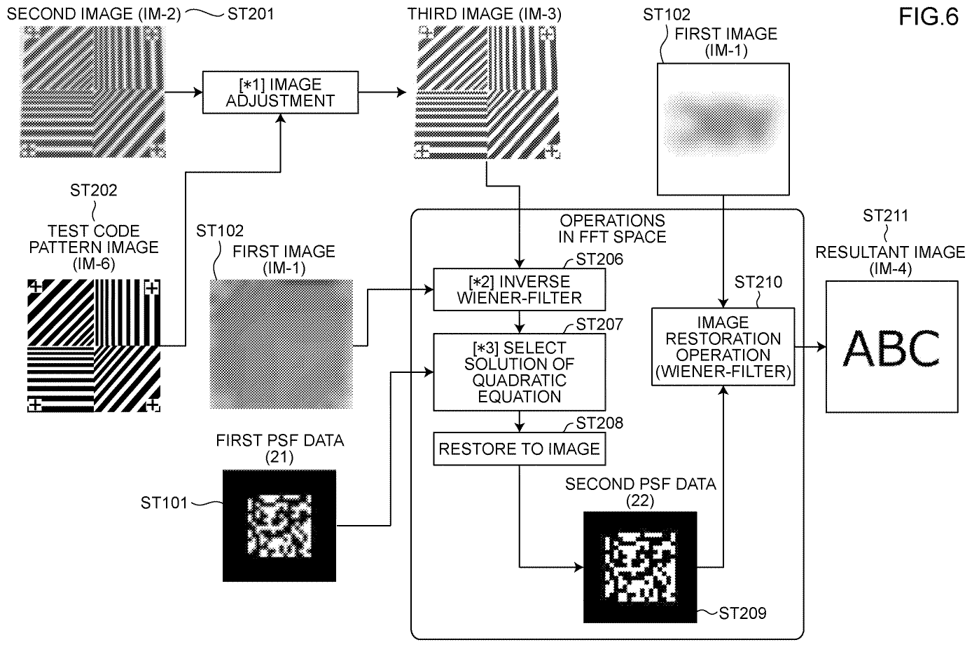

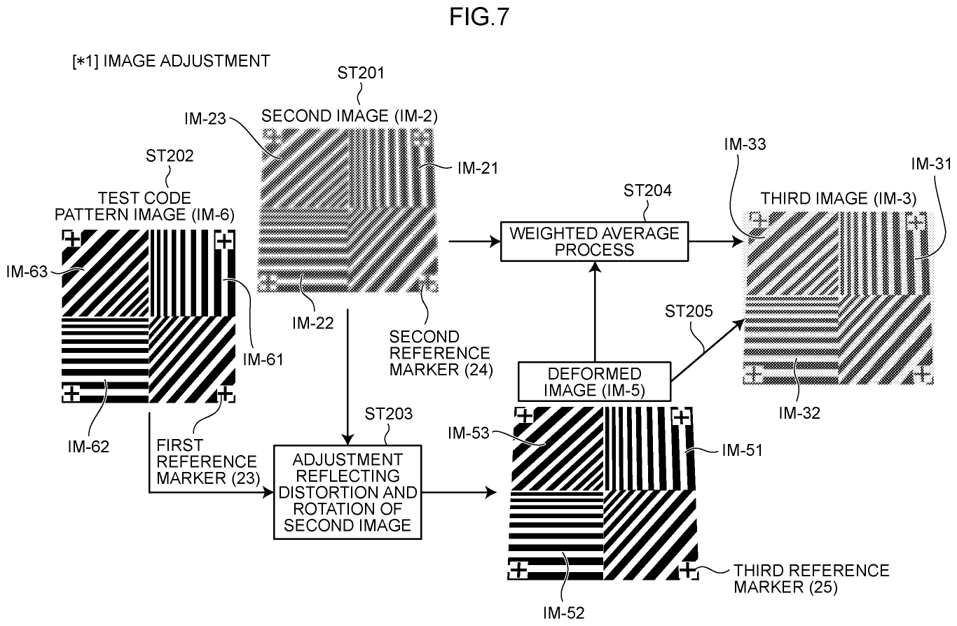

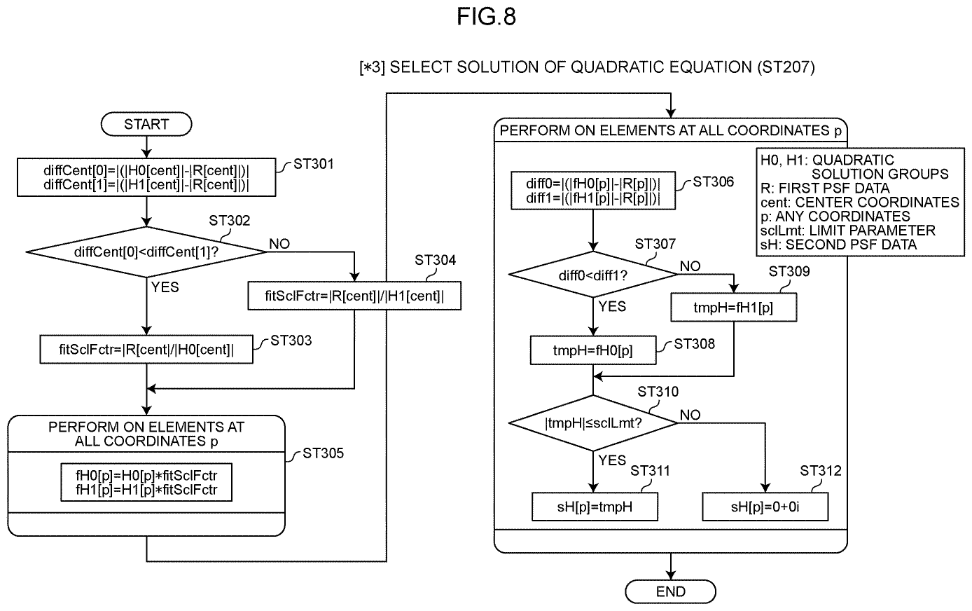

The following describes the image processing according to the present embodiment. FIG. 5 is a schematic diagram illustrating a procedure to acquire the second image according to the embodiment. FIG. 6 is a schematic diagram illustrating a procedure to acquire the resultant image according to the embodiment. FIG. 7 is a schematic diagram illustrating a procedure of an image adjustment illustrated in FIG. 6. FIG. 8 is a flowchart illustrating a procedure to select a solution of a quadratic equation in FIG. 6.

As illustrated in FIG. 6, in broad outline, the image processing according to the present embodiment generates the resultant image IM-4 by performing the deconvolution process based on the second PSF data 22 and the first image IM-1. A “Wiener filter” process illustrated in FIG. 6 is an example of the deconvolution process. In particular, in the present embodiment, the process is characterized in that the second PSF data 22 is generated. The second PSF data 22 is generated by performing a spatial fast Fourier transform (FFT) operation on the third image IM-3. The third image IM-3 is generated based on the second image IM-2 and a test code pattern image IM-6. Therefore, the generation of the second image IM-2 will first be described.

### Generation of Second Image

As a precondition, the second image IM-2 is acquired. That is, as illustrated in FIG. 5, the processing circuit 74 (refer to FIG. 4) generates the second image IM-2 by performing an image restoration operation (Wiener filter process) using the first PSF data 21 on the first image IM-1 obtained by capturing the subject 101. The following is a detailed explanation with reference to FIG. 5.

As illustrated in FIG. 5, the storage circuit 73 (refer to FIG. 4) first stores therein the first PSF data 21 that indicates the light/dark distribution captured by the optical sensor 10 in the state where the point light source 105 faces the code mask 60 (Step ST101). The time to store the first PSF data 21 is, for example, when the imaging device 1 is designed or shipped, or when the imaging device 1 starts.

The storage circuit 73 then stores therein the first image IM-1 obtained by capturing the subject 101 through the code pattern 61 of the code mask 60 (Step ST102). Then, the processing circuit 74 (refer to FIG. 4) reads out the first image IM-1 and the first PSF data 21 and performs the image restoration operation using the first PSF data 21 on the first image IM-1 (Step ST103) to generate the second image IM-2 (Step ST104). The storage circuit 73 stores therein the second image IM-2.

Instead of the subject 101 illustrated in FIG. 5, the test code pattern image IM-6 illustrated in FIGS. 6 and 7 is used as a subject of the second image IM-2 illustrated in FIGS. 6 and 7. That is, in FIGS. 6 and 7, the image data obtained by capturing the test code pattern image IM-6 through the code pattern 61 of the code mask 60 is set as the first image IM-1, and the image restoration operation using the first PSF data 21 is performed on the first image IM-1 to generate the second image IM-2. The storage circuit 73 stores therein the data of the second image IM-2.

Then, as illustrated in FIG. 6, the third image IM-3 is generated based on the second image IM-2 and the test code pattern image IM-6. This process uses a deformed image IM-5 that is obtained by deforming the test code pattern image IM-6. Therefore, the generation of the deformed image IM-5 will be described below.

### Generation of Deformed Image

The following describes the generation of the deformed image illustrated in FIG. 7. As illustrated in FIG. 7, the processing circuit 74 first reads out the second image IM-2 (Step ST201). The data of the second image IM-2 is stored in advance in the storage circuit 73. The processing circuit 74 also reads out the test code pattern image IM-6 stored in the storage circuit 73 (Step ST202). For example, a drawing of the subject 101 is applicable as the test code pattern image IM-6.

The following describes the shape of the second image IM-2 and the test code pattern image IM-6 illustrated in FIG. 7. Each of the second image IM-2 and the test code pattern image IM-6 has, for example, a quadrilateral overall outer shape, and in addition, is formed of four adjacent quadrilaterals. A plurality of vertical lines IM-61, a plurality of horizontal lines IM-62, and a plurality of diagonal lines IM-63 are arranged in the four quadrilaterals that form the test code pattern image IM-6. The vertical lines IM-61, the horizontal lines IM-62, and the diagonal lines IM-63 become thinner toward the inside. The test code pattern image IM-6 preferably includes a variety of frequency components in a plurality of directions including vertical and horizontal directions. Thus, the test code pattern image IM-6 has predetermined patterns. In addition, a first reference marker 23 of a “+” (plus) sign is located in each of the four corners of the test code pattern image IM-6. Also, a plurality of vertical lines IM-21, a plurality of horizontal lines IM-22, and a plurality of diagonal lines IM-23 are arranged in the four quadrilaterals forming the second image IM-2 generated using the test code pattern image IM-6 as the subject; and a second reference marker 24 is located in each of the four corners of the second image IM-2. In addition, a plurality of vertical lines IM-51, a plurality of horizontal lines IM-52, and a plurality of diagonal lines IM-53 are arranged in the four quadrilaterals forming the deformed image IM-5; and a third reference marker 25 is located in each of the four corners of the deformed image IM-5.

The processing circuit 74 then adjusts the test code pattern image IM-6 to generate the deformed image IM-5 (Step ST203). Specifically, the processing circuit 74 deforms the test code pattern image IM-6 such that the first reference markers 23 in the test code pattern image IM-6 overlap the second reference markers 24 in the second image IM-2, thus generating the deformed image IM-5. That is, the test code pattern image IM-6 has a square outer shape, and the distances between the four first reference markers 23 are equal. However, since the outer shape of the second image IM-2 is trapezoidal, the distance between the upper two second reference markers 24 of the four second reference markers 24 is shorter than the distance between the lower two second reference markers 24. Therefore, the deformed image IM-5 obtained by adjusting the test code pattern image IM-6 has the same trapezoidal shape as the outer shape of the second image IM-2. Thus, the adjustment at Step ST203 is an adjustment that reflects the distortion and rotation of the second image IM-2 onto the test code pattern image IM-6.

### Generation of Third Image

The following describes the generation of the third image IM-3. Two methods of the image processing are available to generate the third image. The following is a detailed explanation with reference to FIG. 7.

As illustrated in FIG. 7, in the first image processing method, the processing circuit 74 performs a weighted averaging process on the deformed image IM-5 with the second image IM-2 (Step ST204) to generate the third image IM-3. The “weighted averaging process” refers to a process in which a plurality of pixels in the deformed image IM-5 are associated with a plurality of pixels in the second image IM-2, and a weighted average of a pixel of the deformed image IM-5 and a corresponding pixel of the second image IM-2 at a predetermined ratio is performed for each pair of the associated pixels. The predetermined proportion of the second image IM-2 in the weighted averaging process is, for example, 60% or less.

In the second image processing method, the processing circuit 74 sets the deformed image IM-5 as the third image IM-3 (Step ST205). That is, the second image processing is image processing to set the deformed image IM-5 as the third image IM-3 without performing the weighted averaging process on the deformed image IM-5.

### Inverse Wiener Filter Operation

The following describes an “inverse Wiener filter” (Step ST206) illustrated in FIG. 6. The “Wiener-filter” will first be explained. When X denotes the Fourier transform of a subject image, and Y denotes the Fourier transform of a captured image, Expression (1) given below is obtained.

X≈\hat{X}=W·Y (1)

In Expression (1), X with a caret (X with a superscript \hat{ }) denotes an approximate solution of X, and W denotes the Wiener filter, which is a function expressed by Expression (2) given below.

$$W = \frac{{H}^{*}}{{\vert H \vert}^{2} + Γ} \qquad ( 2 )$$

In Expression (2), H denotes the Fourier transform of the PSF data (spread function); H* denotes the complex conjugate of H; and Γ denotes a constant that depends on the signal-to-noise ratio (S/N) of the pixel data Cap.

The following describes the “inverse Wiener filter”. First, the Wiener filter will be solved for H. Assume that a, b, c, and d are given by Expressions (3) and (4) below. “p” indicates coordinates on FFT data.

$$\begin{matrix}a = {H [ p ]}_{re} , b = {H [ p ]}_{im} \\ {□}_{re} : Real part , {□}_{im} : Imaginary part \\ P : Coordinates on FFT data\end{matrix} \qquad ( 3 )$$

$$c = {( \frac{\hat{X}}{Y} )}_{re} d = {( \frac{\hat{X}}{Y} )}_{im} \qquad ( 4 )$$

When c≠0, Expression (5) below is obtained.

$$a = \frac{c ( 1 \pm \sqrt{1 - 4 ( {c}^{2} + {d}^{2} ) Γ} )}{2 ( {c}^{2} + {d}^{2} )} , b = - \frac{d}{c} a \qquad ( 5 )$$

When c=0 and d≠0, Expression (6) below is obtained.

$$a = 0 , b = \frac{- 1 \pm \sqrt{1 - 4 {d}^{2} Γ}}{2 d} \qquad ( 6 )$$

When c=0 and d=0, a=0 and b=0.

As described above, the processing circuit 74 solves the Wiener filter for H to obtain two solutions of a quadratic equation, with a ± sign for the second term.

### Selection of Solution of Quadratic Equation

Then, as illustrated in FIG. 6, the processing circuit 74 selects the optimal solution from the two solutions of the quadratic equation (Step ST207). The following describes a procedure to select the optimal solution from the two solutions, with reference to FIG. 8. As illustrated in the flowchart in FIG. 8, first, the difference between the absolute value of the center coordinate value (direct-current (DC) component) in the FFT data of each of two quadratic solution groups (H0, H1) and the absolute value of the center coordinate value (DC component) in the FFT data of the first PSF data (R) is calculated (Step ST301). Then, the differences between the center values calculated at Step ST301 are compared (Step ST302). If the difference of a quadratic solution group H0 is smaller, the ratio of the center value of the quadratic solution group H0 to the center value of the first PSF data (R) is held as fitSclFctr (Step ST303). If the difference of a quadratic solution group H1 is smaller, the ratio of the center value of the quadratic solution group H1 to the center value of the first PSF data (R) is held as fitSclFctr (Step ST304). Then, elements of the quadratic solution groups H0 and H1 are multiplied by fitSClFctr to be converted to scale-aligned values fH0 and fH1 (Step ST305). This conversion is performed on the elements at all coordinates p.

Then, the difference between the absolute value of each of fH0 and fH1 and the absolute value of the first PSF data (R) at the same coordinates is calculated (Step ST306). This calculation is also performed on the elements at all the coordinates p. Then, the difference of fH0 is compared with the difference of fH1 (Step ST307), and the value of fH0 or fH1 that has a smaller difference from the PSF is stored. For example, at Step ST308, the storage circuit 73 stores therein fH0 because the difference of fH0 is smaller. At Step ST309, the storage circuit 73 stores therein fH1 because the difference of fH1 is smaller.

Then, the absolute value of the stored value is compared with the range of a limit parameter sclLmt (Step ST310). If the absolute value of the stored value does not exceed the range of the limit parameter sclLmt, the stored value is employed as the second PSF data, and if the absolute value of the stored value exceeds the range of the limit parameter sclLmt, the coordinates are set to null (0+0i). For example, at Step ST311, the absolute value of the stored value does not exceed the range of the limit parameter sclImt, and the stored value is employed as the second PSF data. At Step ST312, the absolute value of the stored value exceeds the range of the limit parameter sclLmt, and the coordinates are set to null (0+0i). Thus, the processing circuit 74 uses the stored value as the second PSF data, and the selection of the solution of the quadratic equation (Step ST207) illustrated in FIG. 6 ends.

### Generation of Second PSF Data

The following describes the generation of the second PSF data 22 illustrated in FIG. 6. The stored value mentioned above is used as the second PSF data. The second PSF data is data in the fast Fourier transform (FFT) space. Therefore, as illustrated in FIG. 6, the processing circuit 74 restores the second PSF data to an image (Step ST208) to generate the second PSF data 22 as the image (Step ST209). As described above, the processing circuit 74 performs the image processing to generate the second PSF data 22 based on the third image IM-3 and the first PSF data 21. The storage circuit 73 stores therein the second PSF data 22.

### Generation of Resultant Image

As illustrated in FIG. 6, the processing circuit 74 performs the image processing in which the deconvolution process is performed based on the second PSF data 22 and the first image IM-1 (Step ST210) to generate the resultant image IM-4 (Step ST211). The following is a detailed explanation of the image processing.

The Wiener filter as the image restoration operation is included in the deconvolution process. The second PSF data 22 illustrated in FIG. 6 is the image data generated at Step ST209. The first image IM-1 is the image data obtained by capturing the subject 101 through the code pattern 61 of the code mask 60. The second PSF data 22 and the first image IM-1 are stored in the storage circuit 73. Therefore, the processing circuit 74 reads out the second PSF data 22 and the first image IM-1 from the storage circuit 73, and performs the deconvolution process based on the second PSF data 22 and the first image IM-1 to generate the resultant image IM-4. The resultant image IM-4 is stored in the storage circuit 73. The above-described processing obtains the resultant image IM-4 generated using the second PSF data 22 that has higher accuracy than the first PSF data 21.

As described above, the imaging device 1 according to the present embodiment includes the planar optical sensor 10, the code mask 60 on which the code pattern 61 is displayed, the subject housing 103 that accommodates therein the subject 101, the storage circuit 73 that stores therein the first PSF data 21 and the first image IM-1, and the processing circuit 74 that performs the image processing to generate the resultant image IM-4 by performing the deconvolution process based on the second PSF data 22 and the first image IM-1.

As described with reference to FIG. 5, the first PSF data 21 indicates the light/dark distribution of the light from the point light source 105 captured by the optical sensor 10 through the code pattern 61 of the code mask 60. The second PSF data 22 is the image data obtained by adjusting the first PSF data 21. In the present embodiment, the image processing is performed to generate the resultant image IM-4 by performing the deconvolution process based on the second PSF data 22 and the first image IM-1. Therefore, compared with the second image IM-2 obtained by performing the deconvolution process based on the first PSF data 21 and the first image IM-1, the resultant image IM-4 according to the present embodiment can be captured as a clearer image with reduced blur.

The processing circuit 74 performs the image processing to generate the third image IM-3 by performing a weighted average of the test code pattern image IM-6, which has the predetermined patterns, and the second image at a predetermined ratio and generate the second PSF data 22 based on the third image IM-3 and the first PSF data 21. Thus, since the second PSF data 22 according to the present embodiment has a higher accuracy than the first PSF data 21, the resultant image IM-4 according to the present embodiment can be captured as a clearer image with reduced blur.

The processing circuit 74 generates the deformed image IM-5 obtained by deforming the test code pattern image IM-6 such that the first reference markers 23 in the test code pattern image IM-6 overlap the second reference markers 24 in the second image IM-2. The test code pattern image IM-6 is, for example, data, such as a drawing, of the subject 101.

The processing circuit 74 performs the image processing to set the deformed image IM-5 as the third image IM-3 or perform a weighted average of the deformed image IM-5 and the second image IM-2 to generate the third image IM-3. The proportion of the second image IM-2 is 60% or less in the weighted averaging process. Thus, since the second PSF data 22 is generated by the third image IM-3 using the deformed image IM-5, the resultant image IM-4 according to the present embodiment can be captured as a clearer image with reduced blur. If the proportion of the second image IM-2 in the weighted averaging process is greater than 608, the clarity of the resultant image IM-4 decreases. Therefore, the proportion of the second image IM-2 is preferably less 60% or less.

The processing circuit 74 performs the inverse operation of the Wiener filter on the third image IM-3 to obtain the two solutions, selects one of the two solutions for each element of the FFT by performing the coordinate transformation in the fast Fourier transform (FFT) using the first PSF data 21, and performs processing to return the selected one of the solutions back to the image, thereby generating the second PSF data 22. Thus, in the present embodiment, the image processing, such as the inverse operation of the Wiener filter, is performed on the third image IM-3. Therefore, the resultant image IM-4 according to the present embodiment can be captured as a clearer image with reduced blur.

The code pattern 61 in the code mask 60 includes the light-transmitting portions 61a and the light-blocking portions 61b. The total area of the light-transmitting portions 61a in the code pattern 61 is 40% to 60% of the area of the code pattern 61. Due to frequency characteristics in the FFT processing, exceeding this range causes a disadvantage that the quality of the deconvolution process decreases.

### MODIFICATION

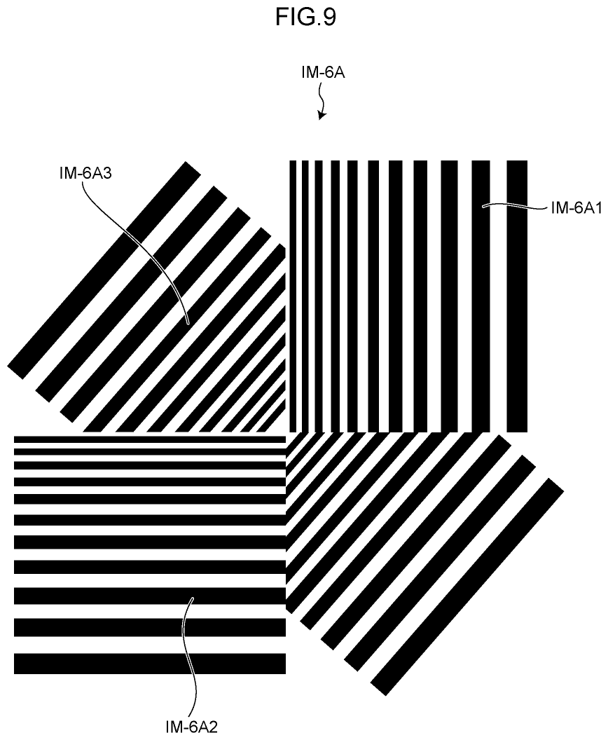

The following describes a modification of the test code pattern image. FIG. 9 is a schematic view illustrating a test code pattern image according to a modification of the embodiment. As illustrated in FIG. 9, a test code pattern image IM-6A according to the modification has predetermined patterns. Specifically, the predetermined patterns having a quadrilateral outer shape are included at the upper right and the lower left in FIG. 9. In the upper right quadrilateral, a plurality of vertical lines IM-6A1 are horizontally arranged, and the vertical lines IM-6A1 become thinner toward the left side. In the lower left quadrilateral, a plurality of horizontal lines IM-6A2 are vertically arranged, and the horizontal lines IM-6A2 become thinner toward the upper side. In the upper left and lower right portions, a plurality of diagonal lines IM-6A3 that become thinner toward the center are arranged. The diagonal lines IM-6A3 intersects the vertical lines IM-6A1 at an angle of, for example, 45 degrees. Thus, the test code pattern image IM-6A is preferably an image that includes a variety of frequency components in a plurality of directions including the vertical and the horizontal directions.

As described above, the test code pattern image IM-6A according to the modification is the image that includes a variety of frequency components in the multiple directions including the vertical and the horizontal directions and has predetermined patterns, in the same way as the test code pattern image IM-6 according to the embodiment. Thus, the test code pattern image according to the present invention can be applied to various examples that include various predetermined patterns, in addition to the test code pattern image IM-6 according to the embodiment.

What is claimed is:

1. An imaging device comprising:
a planar optical sensor comprising a plurality of photodiodes;
a code mask that is disposed on one side in a first direction of the optical sensor so as to overlap the optical sensor and on which a code pattern is configured to be displayed;
a subject housing that is disposed on the one side in the first direction of the code mask so as to overlap the code mask and is configured to accommodate a subject;
a storage circuit configured to store first point spread function (PSF) data and a first image, the first PSF data indicating a light/dark distribution of light from a point light source captured by the optical sensor through the code pattern of the code mask, and the first image being an image of the subject captured by the optical sensor through the code pattern of the code mask; and
a processing circuit configured to perform image processing to generate a second image by performing a deconvolution process based on the first PSF data and the first image, adjust the first PSF data to generate second PSF data, and generate a resultant image by performing the deconvolution process based on the second PSF data and the first image.

2. The imaging device according to claim 1, wherein the processing circuit is configured to generate a third image by performing a weighted average of a test code pattern image that has predetermined patterns and the second image at a predetermined ratio.

3. The imaging device according to claim 2, wherein the processing circuit is configured to perform image processing to generate the second PSF data based on the third image and the first PSF data.

4. The imaging device according to claim 2, wherein
the test code pattern image has first reference markers at a plurality of predetermined locations, and the second image has second reference markers at a plurality of predetermined locations, and
the processing circuit is configured to generate a deformed image obtained by deforming the test code pattern image such that the first reference markers of the test code pattern image overlap the second reference markers of the second image.

5. The imaging device according to claim 4, wherein the processing circuit is configured to perform image processing to set the deformed image as the third image.

6. The imaging device according to claim 4, wherein the processing circuit is configured to generate the third image by performing a weighted average of the deformed image and the second image, and the proportion of the second image in the weighted averaging is 60% or less.

7. The imaging device according to claim 3, wherein the processing circuit is configured to generate the second PSF data by performing image processing to obtain two solutions by performing an inverse operation of a Wiener filter on the third image, and selecting one of the two solutions for each element of a fast Fourier transform (FFT) by performing a coordinate transformation in the FFT using the first PSF data, and returning the selected one of the solutions back to the image.

8. The imaging device according to claim 1, wherein
the code pattern in the code mask comprises light-transmitting portions and light-blocking portions, and
a total area of the light-transmitting portions in the code pattern is 40% to 60% of an area of the code pattern.
